(19) United States
(12) Patent Application Publication
(10) Pub. No.: US 2013/0130011 A1
(43) Pub. Date: May 23, 2013

(54) METHOD FOR PREPARING GRAPHENE, GRAPHENE SHEET, AND DEVICE USING SAME

(71) Applicants: Byung Hee Hong, Seoul (KR); Jong-Hyun Ahn, Suwon-si (KR); Su Kang Bae, Suwon-si (KR); Myung Hee Jung, Suwon-si (KR); Hye Ri Kim, Suwon-si (KR); Sang Jin Kim, Suwon-si (KR)

(72) Inventors: Byung Hee Hong, Seoul (KR); Jong-Hyun Ahn, Suwon-si (KR); Su Kang Bae, Suwon-si (KR); Myung Hee Jung, Suwon-si (KR); Hye Ri Kim, Suwon-si (KR); Sang Jin Kim, Suwon-si (KR)

(73) Assignee: SUNGKYUNKWAN UNIVERSITY FPUNDATION FOR CORPORATE COLLABORATION, Suwon-si (KR)

(21) Appl. No.: 13/813,228

(22) PCT Filed: Jul. 29, 2011
(86) PCT No.: PCT/KR2011/005600

§ 371 Date: Jan. 30, 2013

(30) Foreign Application Priority Data
Jul. 30, 2011 (KR) 10-2010-0074323

(51) Int. Cl. C01B 31/04

(52) U.S. Cl. CPC C01B 31/0453
USPC 428/220; 427/249.1; 427/577; 428/688; 428/702; 428/698; 428/408

(57) ABSTRACT

THE PRESENT INVENTION PROVIDES A METHOD FOR PREPARING GRAPHENE BY PROVIDING A REACTION GAS INCLUDING A CARBON SOURCE AND HEAT ONTO A SUBSTRATE, AND REACTING THE SAME TO FORM A GRAPHENE ON THE SUBSTRATE, A GRAPHENE SHEET FORMED BY THE METHOD, AND A DEVICE USING THE SAME.

### CROSS REFERENCE TO RELATED APPLICATIONS

This application is a national stage application of International Application No. PCT/KR2011/005600, filed Jul. 29, 2011, claiming priority based on Korean Patent Application No. 10-2010-0074323 filed Jul. 30, 2010, the contents of all of which are incorporated herein by reference in their entirety.

### TECHNICAL FIELD

The present disclosure relates to a method for preparing graphene by supplying a reaction gas including a carbon source and heat onto a substrate that does not include a catalyst and making a reaction to form graphene on the substrate, a graphene sheet formed by the method, and a device using the same.

### BACKGROUND ART

Graphene is a one atom-layer of conductive substance made of carbon atoms arranged in a honeycomb pattern of two dimensions. Graphene may form graphite three-dimensionally stacked, a carbon nanotubes one-dimensionally rolled, and zero-dimensional fullerene in a ball shape. The graphene has been an important model for study of various low dimensional nano phenomena. Graphene is very stable structurally and chemically and is a very excellent conductor. It had been anticipated that electrons in graphene can move about 100 times faster than in silicon and electric current in graphene can flow about 100 times more than in copper. This was demonstrated through experiments in 2004 when a method of separating graphene from graphite was found, which has excited scientists all over the world for the last several years.

Graphene is made of pure carbon which is a relatively light atom, and, thus, it is very easy to process graphene in a one-dimensional or two-dimensional nano pattern. With this feature, it is possible to control semiconductive and conductive properties and also possible to manufacture various functional devices including sensors and memories using various chemical bonds of carbon. Graphene is included on its “world's top 100 future technologies” list for 2008 chose by the Massachusetts Institute of Technology (MIT). Recently, Korea Institute of S&T Evaluation and Planning (KISTEP) and Samsung Economic Research Institute (SERI) chose a graphene-related technology as one of “top 10 most promising technologies”. In Korea, a graphene-related research is at an early stage and a small-scale national mission thereof started last year. Therefore, Korea is lagging behind U.S., Japan, and Europe.

Despite excellent electrical, mechanical, and chemical characteristics of graphene described above, a research of an applicable technology has been limited since a mass producing method of graphene has not been developed. In a conventional mass producting method, graphite is ground mechanically and dispersed in a solution and a thin film is formed by means of a self-assembly phenomenon. Although graphene can be produced at a relatively low cost by the conventional method, electrical and mechanical characteristics cannot meet the expectations due to a graphene structure in which numerous graphene pieces are overlapped and connected with each other.

Due to a recent surge in demand for flat panel displays, a global transparent electrode market is expected to grow to about twenty trillion won within about 10 years. With development of a display industry in Korea, a domestic demand for transparent electrodes reaches hundreds of billions of wons every year. However, due to a lack of source technologies, Korea depends heavily on imports for transparent electrodes. An ITO (Indium Tin Oxide) as a representative transparent electrode is widely applied to a display, a touch screen, a solar cell, and the like. However, recently, a lack of indium has contributed to an increase in cost, and, thus, there has been an urgent need to develop a substitute substance. Further, due to fragility of the ITO, there has been a limit in applications of the ITO to next-generation electronic devices which is foldable, bendable, and extendable. Graphene has been expected to have excellent elasticity, flexibility, and transparency and also expected to be produced and patterned by a relatively simple method. It is anticipated that a graphene electrode has a great import substitution effect if a mass production technology thereof can be established hereafter and also has an innovative ripple effect on the whole technologies in a next-generation flexible electronic industry.

However, a mass production technology of graphene and an applicable technology using mass-produced graphene have not been developed, and, thus, a demand for development of these technologies has been increased.

### DISCLOSURE OF THE INVENTION

### Problems to Be Solved by the Invention

In view of the foregoing, the present disclosure provides a method for preparing graphene by supplying a carbon source onto a substrate that does not include a catalyst through a chemical vapor deposition process. In this method, a graphene sheet of a large area can be prepared easily and economically on the substrate that does not include a catalyst. Further, the present disclosure provides a graphene sheet formed by the above-described method and a device using the same.

However, the problems to be solved by the present invention are not limited to the above description and other problems can be clearly understood by those skilled in the art from the following description.

### Means for Solving the Problems

In accordance with a first aspect of the present disclosure, there is provided a preparing method of graphene including supplying a reaction gas including a carbon source and heat onto a substrate and making a reaction to form graphene on the substrate.

In accordance with a second aspect of the present disclosure, there is provided a preparing method of graphene including loading a substrate into an ICP-CVD chamber by using a load-locked chamber; and supplying a carbon source into the ICP-CVD chamber to form graphene by an ICP-CVD process at about 1,000° C. or less.

In accordance with a third aspect of the present disclosure, there is provided a graphene sheet including a substrate; and graphene formed on the substrate by the methods of first or second aspects of the present disclosure.

In accordance with a fourth aspect of the present disclosure, there is provided a device including graphene formed by the methods of first or second aspects of the present disclosure.

### EFFECT OF THE INVENTION

In accordance with the present disclosure, graphene can be prepared easily by supplying a reaction gas including a carbon source and heat onto a substrate that does not include a catalyst and making a reaction. Further, graphene with transparency can be used safely at a high temperature. The method of the present disclosure can be applied to an inexpensive substrate, which results in cost reduction.

In accordance with the present disclosure, graphene is formed on the substrate, i.e. non-catalytic substrate, that does not include a catalyst, and, thus, a process of removing a catalytic layer is not needed, which results in simplication of a preparing process. Further, a device can be manufactured by directly pattering the formed graphene without an additional transcription process, and, thus, graphene can be applied to various graphene-based electric/electronic devices.

### BRIEF DESCRIPTION OF THE DRAWINGS

FIG. 1 is a conceptual diagram illustrating an apparatus for preparing graphene in accordance with an illustrative embodiment of the present disclosure.

FIG. 2 is a process diagram illustrating a method for preparing graphene in accordance with an illustrative embodiment of the present disclosure.

FIG. 3 provides images of a sapphire (Al₂O₃) substrate (a) before and (b) after graphene is formed thereon in accordance with an example of the present disclosure.

FIG. 4 is a graph showing a Raman spectrum of graphene depending on a change in plasma power by using C₂H₂ as a carbon source in accordance with an example of the present disclosure.

FIG. 5 is a graph showing a change in transparency of graphene depending on a change in plasma power by using C₂H₂ as a carbon source in accordance with an example of the present disclosure.

FIG. 6 is a graph showing a Raman spectrum of graphene depending on a change in reaction time by using C₂H₂ as a carbon source in accordance with an example of the present disclosure.

FIG. 7 is a graph showing a change in transparency of graphene depending on a change in reaction time by using C₂H₂ as a carbon source in accordance with an example of the present disclosure.

FIG. 8 is a graph showing a Raman spectrum of graphene depending on a change in plasma power by using CH₄ as a carbon source in accordance with an example of the present disclosure.

FIG. 9 is a graph showing transmittance of graphene depending on a change in plasma power by using CH₄ as a carbon source in accordance with an example of the present disclosure.

### BEST MODE FOR CARRYING OUT THE INVENTION

Hereinafter, embodiments of the present disclosure will be described in detail with reference to the accompanying drawings so that the present disclosure may be readily implemented by those skilled in the art.

However, it is to be noted that the present disclosure is not limited to the embodiments but can be embodied in various other ways. In drawings, parts irrelevant to the description are omitted for the simplicity of explanation, and like reference numerals denote like parts through the whole document.

Further, the term “comprises or includes” and/or “comprising or including” used in the document means that one or more other components, steps, operation and/or existence or addition of elements are not excluded in addition to the described components, steps, operation and/or elements unless context dictates otherwise.

The term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”. Through the whole document, the term “on” that is used to designate a position of one element with respect to another element includes both a case that the one element is adjacent to the another element and a case that any other element exists between these two elements.

The term “graphene” or “graphene sheet” means sheet-shaped graphene in which numerous carbon atoms are joined together with a covalent bond to form a polycyclic aromatic molecule and the multiple carbon atoms joined together with a multiple covalent bond have a six-membered ring as a fundamental repeat unit and may further include a five-membered ring and/or a seven-membered ring. Therefore, the graphene sheet looks like a monolayer of covalent carbon atoms (typically, sp² bonding). The sheet may have various structures and these structures may depend on a five-membered ring content and/or a seven-membered ring content of graphene. As described above, the graphene sheet may be formed of a monolayer of graphene and can be formed of multiple stacked layers. Typically, a side end of the graphene may be saturated with hydrogen atoms.

The term “inductively coupled plasma-chemical vapor deposition (ICP-CVD)” will be referred to as “ICP-CVD” below.

In accordance with a first aspect of the present disclosure, there is provided a preparing method of graphene including supplying a reaction gas including a carbon source and heat onto a substrate and making a reaction to form graphene on the substrate. In accordance with an illustrative embodiment, the graphene may be formed by, but not limited to, an inductively coupled plasma-chemical vapor deposition (ICP-CVD) process, a low pressure chemical vapor deposition (LPCVD) process or an atmospheric pressure chemical vapor deposition (APCVD) process. In accordance with an illustrative embodiment, a temperature of the reaction may be, but not limited to, about 1,000° C. or less.

In accordance with a second aspect of the present disclosure, there is provided a graphene preparing method including loading a substrate into an ICP-CVD chamber by using a load-locked chamber and supplying a carbon source into the ICP-CVD chamber to form graphene by an ICP-CVD process at about 1,000° C. or less.

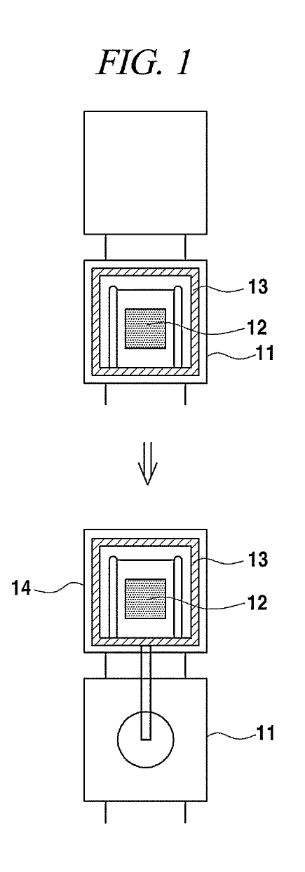

During the ICP-CVD process, high-density plasma can be generated at a low pressure to form graphene. FIG. 1 is a conceptual diagram illustrating an apparatus for preparing graphene in accordance with an illustrative embodiment of the present disclosure. There will be schematically explained a preparing method of graphene by using the ICP-CVD apparatus with reference to FIG. 1. By using a typical ICP-CVD apparatus, a substrate 12 may be loaded into ICP-CVD apparatus by using a load-locked chamber 13 within a transfer chamber 11. While an ICP-CVD chamber 15 in which the substrate is loaded is maintained at a vacuum level of, for example, from about 5 mTorr to about 100 mTorr, a reaction gas including a carbon source is supplied into the ICP-CVD chamber 15. Further, plasma is generated within the chamber 15 by an induced magnetic field generated by applying a high frequency power of about several hundred kHz to about several hundred MHz. Thus, graphene can be formed on the loaded substrate 12 with the carbon source. Desirably, the reaction gas including the carbon source may be supplied into the ICP-CVD chamber 15 in which the substrate is loaded at, but not limited to, a steady pressure. During the ICP-CVD process, it is important to generate uniform plasma by uniformly spraying the carbon source to the entire substrate, and the graphene can be formed while a temperature of the substrate is maintained at about 1,000° C. or less.

In accordance with an illustrative embodiment, the preparing method of graphene may further include, but is not limited to, cooling the formed graphene. A process of cooling the graphene is provided to uniformly grow and regular arrange the graphene formed by the ICP-CVD process. Rapid cooling may cause cracks in the graphene, and, thus, it is desirable to perform gradual cooling at a constant rate if possible. By way of example, cooling may be performed at a rate of about 10° C. or less per minute or natural cooling may be performed, but the present disclosure is not limited to. The natural cooling is performed by just removing a heat source used for a heating process. A sufficient cooling rate can be obtained by just removing the heat source.

In accordance with an illustrative embodiment, the preparing method of graphene may further include, but is not limited to, pattering the formed graphene. In accordance with another illustrative embodiment, the substrate may include, but is not limited to, a non-catalytic substrate. The graphene obtained in accordance with the present disclosure can be formed by contacting the non-catalytic substrate with the carbon source to perform the ICP-CVD process and cooling it without any complicated process. Therefore, the process is simple and economical, and a graphene sheet of a large area can be prepared by freely adjusting a size of the substrate on which the graphene is formed. Further, if the substrate is a non-catalytic substrate, graphene can be formed on a target substrate and the graphene formed on the target substrate can be patterned immediately unlike a conventional process in which after graphene is formed, a catalyst layer is removed and the graphene is transcribed to a target substrate and then patterned. If necessary, the patterned graphene can be used as, but not limited to, an electrode and the like.

In accordance with an illustrative embodiment, the substrate on which the graphene is formed may be, but not limited to, about 1 mm or more wide and long, desirably about 1 cm or more wide and long, and more desirably about 1 cm to about 5 cm wide and long. Since the carbon source is supplied in a gaseous phase, a shape of the substrate is not limited. Therefore, a graphene sheet having various shapes such as a circle, a quadrangle, and a polygon can be obtained. In this case, the transversal and longitudinal lengths of the substrate can be measured by selecting an appropriate position depending on a shape of the graphene sheet. In particular, in case of a circular graphene sheet, the transversal and longitudinal lengths may be the diameter of the graphene sheet. The substrate may include a substrate having a three-dimensional solid shape and a substrate having various particle shapes.

In accordance with an illustrative embodiment, characteristics of the graphene may be controlled by varying, but not limited to, a kind of the carbon source, a reaction pressure, a reaction time, the cooling rate, and a kind of the substrate.

In accordance with an illustrative embodiment, the substrate may be, but not limited to, transparent.

In accordance with an illustrative embodiment, the substrate may be, but not limited to, patterned. In accordance with another illustrative embodiment, a thickness of the substrate may be, but not limited to, in a range of from about 500 μm to about 5 mm.

In accordance with an illustrative embodiment, the substrate may include, but is not limited to, one selected from the group consisting of an oxide, a nitride, and combinations thereof. By way of example, the oxide may be, but not limited to, selected from the group consisting of MgO, Al₂O₃, SiO₂, ZrO₂, Y₂O₃, Cr₂O₃BeO, SnO₂, Eu₂O₃, TiO₂, TiO₂·Al₂O₃, Gd₂O₃, UO₂, (U—Pu)O₂, ThO, complex oxides thereof, and combinations thereof. By way of example, the nitride may be, but not limited to, selected from the group consisting of Si₃N₄, AlN, TiN, BN, CrN, WrN, TaN, BeSiN₂, Ti₂AlN, complex nitrides thereof, and combinations thereof.

If graphene is grown on the substrate of the oxide and/or the nitride, the substrate is not a general substrate but is used for growing graphene. Therefore, the substrate can be loaded directly into the ICP-CVD chamber through the load-locked chamber to form graphene unlike a conventional process in which a substrate is loaded into a sputtering chamber to form a metal catalyst on the substrate. Accordingly, the process can be simplified.

In accordance with an illustrative embodiment, the carbon source may include, but is not limited to, a carbon-containing compound having a carbon number of about 1 to about 10. By way of example, the carbon source may include, but is not limited to, a compound selected from the group consisting of carbon monoxide, carbon dioxide, methane, ethane, ethylene, ethanol, acetylene, propane, propylene, butane, butylene, butadiene, pentane, pentene, pentyne, pentadiene, cyclopentane, cyclopentadiene, hexane, hexene, cyclohexane, cyclohexadiene, benzene, toluene, and combinations thereof. The reaction gas including the carbon source may include only the carbon source or together with an inert gas such as helium and argon. Further, the reaction gas including the carbon source may include hydrogen in addition to the carbon source. The hydrogen can be used to control a gas phase reaction by keeping a surface of the substrate clean. The hydrogen may account for about 1 volume % to about 40 volume %, desirably about 10 volume % to about 30 volume %, and more desirably about 15 volume % to about 25 volume % of the overall volume of the chamber.

In accordance with an illustrative embodiment, characteristics of the graphene may be controlled by adjusting, but not limited to, a plasma power, the reaction time or the cooling rate during the ICP-CVD process. The characteristics of the graphene may include, but are not limited to, resistance, transmittance, a thickness, and crystallinity of the graphene.

By way of example, during the ICP-CVD process for depositing graphene, a thickness of the graphene can be adjusted by adjusting a reaction time at a certain temperature. That is, if the ICP-CVD process is maintained for a long time, a large amount of graphene can be formed. As a result, a thickness of the graphene can be increased. If the ICP-CVD process is performed for a short time, a thickness of the graphene sheet can be decreased. Therefore, in addition to the kind of the carbon source, the supplied pressure, the supplied plasma power, the kind of the non-catalytic substrate, a size of the chamber, the reaction time of the ICP-CVD process is an important factor in obtaining a target thickness of the graphene sheet. Desirably, the reaction time of the ICP-CVD process may be in a range of, for example, from about 0.0001 hour to about 1 hour. If the reaction time is less than about 0.0001 hour, graphene cannot be obtained sufficiently. If the reaction time is more than about 1 hour, graphene may be prepared too much and may be graphited.

Crystallinity of the graphene obtained as described above can be checked from a Raman spectrum. That is, pure graphene shows a G peak at about 1594 cm−1 in a Raman spectrum. Therefore, formation of graphene can be checked from existence of such a peak.

Graphene in accordance with the present disclosure is obtained from a pure material in a gaseous phase through the ICP-CVD process. A D-band in a Raman spectrum means whether or not there is a defect in the graphene. When a peak intensity of the D-band is high, it is deemed that many defects exist in the graphene. When a peak intensity of the D-band is low or there is no D-band, it is deemed that defects scarcely exist in the graphene.

In accordance with an illustrative embodiment, the graphene may include, but is not limited to, graphene of a single layer or multiple layers. The graphene of multiple layers can be prepared by repeatedly performing the ICP-CVD process many times. As the ICP-CVD process is repeated more times, a graphene sheet having many layers and a dense structure can be obtained, but the present disclosure is not limited thereto. The graphene sheet obtained by the process may have a thickness corresponding to, but not limited to, about a single layer to about 300 layers, for example, about a single layer to about 60 layers, about a single layer to about 30 layers, about a single layer to about 20 layers or about a single layer to about 10 layers, of graphene.

In accordance with an illustrative embodiment, the graphene sheet may be doped with a dopant including, but not limited to, an organic dopant, an inorganic dopant or a combination thereof. In accordance with another illustrative embodiment, the dopant may include, but is not limited to, one selected from the group consisting of NO₂BF₄, NOBF₄, NO₂SbF₆, HCl, H₂PO₄, H₃CCOOH, H₂SO₄, HNO₃, PVDF, nafion, AuCl₃, HAuCl₄, SOCl₂, Br₂, dichloro dicyano quinone, oxone, dimyristoyl phosphatidylinositol, trifluoromethanesulfonimide, and combinations thereof.

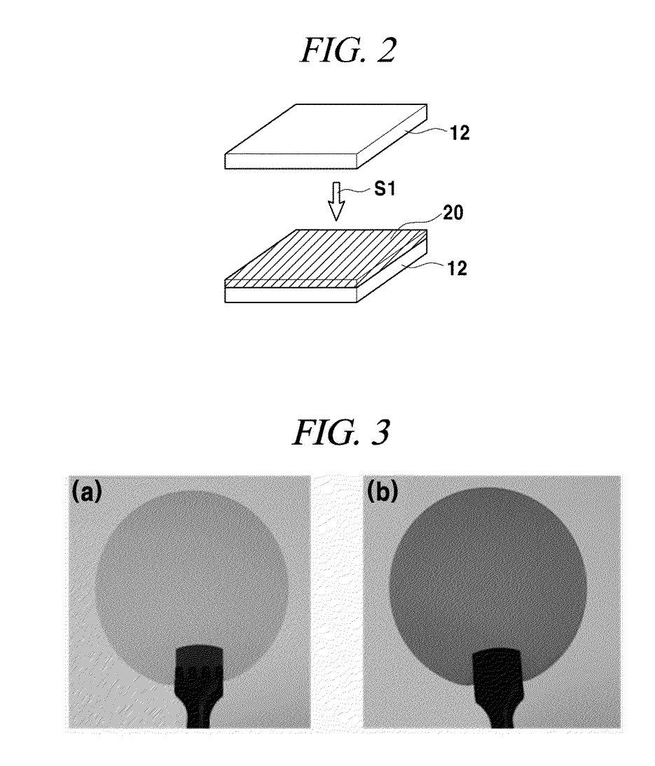

In accordance with a third aspect of the present disclosure, there is provided a graphene sheet including a substrate and graphene formed on the substrate by the above-described preparing method of graphene. FIG. 2 is a process diagram illustrating a method for preparing graphene in accordance with an illustrative embodiment of the present disclosure. Referring to FIG. 2, a graphene sheet can be prepared by forming graphene 12 on a substrate 11 by the above-described method.

In accordance with a fourth aspect of the present disclosure, there is provided a device including graphene formed by the preparing method of graphene in accordance with the present disclosure. In accordance with an illustrative embodiment, the device may include, but is not limited to, an electric/electronic device, a photoelectronic device, an optical device, a light emitting device, or a sensor device.

The graphene sheet and the device including the graphene may include all the above descriptions about the preparing method of graphene and redundant descriptions thereof will be omitted for convenience sake.

Graphene prepared by the above-described method have various uses. The graphene may be effectively used as a transparent electrode due to, for example, its high conductivity and high film uniformity. As for a solar cell, an electrode is provided on a substrate and a transparent electrode is needed for transmitting light. If the graphene sheet is used as the transparent electrode, high conductivity can be obtained. Further, the graphene can be used as, for example, a panel conductive film of various display devices. In this case, conductivity can be obtained as required with a small amount of graphene and an amount of transmitted light can be increased.

Hereinafter, the present disclosure will be explained in detail with reference to examples. However, the present disclosure is not limited thereto.

### EXAMPLE 1

Graphene was formed on a sapphire (Al₂O₃) substrate. To be specific, the sapphire (Al₂O₃) substrate was loaded into an ICP-CVD chamber by using a load-locked chamber and annealed at about 950° C. with a hydrogen gas. Then, a carbon and argon-containing gas (C₂H₂: Ar=60:1 sccm) was supplied thereto at about 10 mTorr for about 15 seconds to about 10 minutes to form graphene was formed on the sapphire (Al₂O₃) substrate by means of ICP-CVD. Thereafter, the graphene was cooled at a rate of about ˜5° C./s to room temperature within the ICP-CVD chamber, so that a graphene sheet grown on the sapphire (Al₂O₃) substrate was obtained. FIG. 3 provides photos of the sapphire (Al₂O₃) substrate (a) before and (b) after graphene was grown thereon.

### EXAMPLE 2

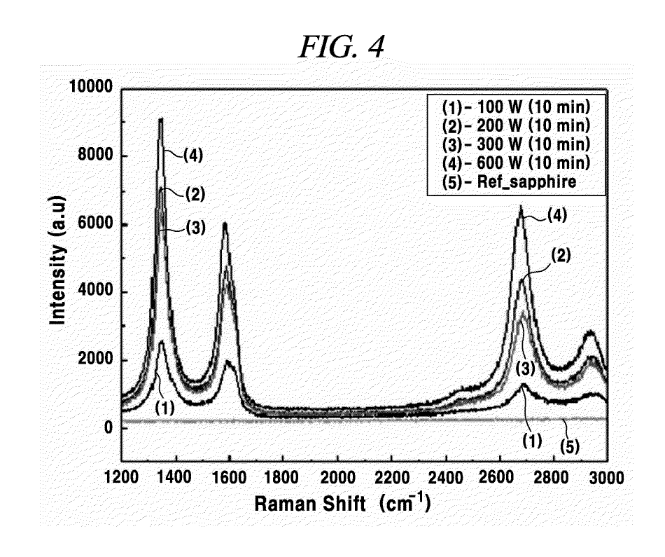

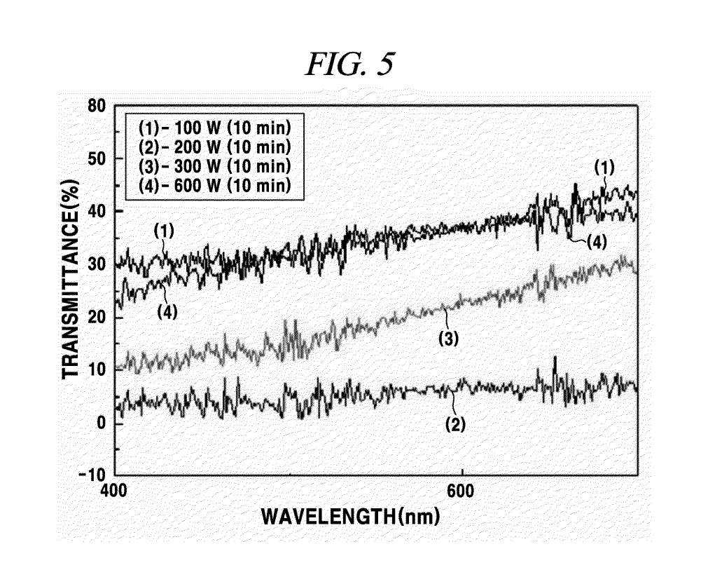

Graphene was formed in the same manner as Example 1. A change in a Raman spectrum, an electrical characteristic (change in resistance), and transmittance of the graphene was observed with change in a plasma power from about 100 W to about 600 W. A result of the observation is shown in Table 1 and FIGS. 4 and 5.

TABLE 1

| | Plasma | Reaction | | Transmittance |
|---|---|---|---|---|
| | power | time | Resistance | (%, 550 nm) |
| 1 | 100 W | 10 min. | 666 Ω | 34 |
| 2 | 200 W | 10 min. | 627 Ω | 3.61 |
| 3 | 300 W | 10 min. | 530 Ω | 16.41 |
| 4 | 600 W | 10 min. | 539 Ω | 33.7 |

Referring to FIG. 4, as a plasma power was increased, an intensity of a 2D peak was increased. Therefore, it could be seen that crystallinity of the graphene was improved. Referring to FIG. 5, transmittance was about 40% or less. Based on the result, a change in an electrical characteristic (change in resistance) and transmittance of the graphene was measured with adjustment of the reaction time without change in the plasma power.

### EXAMPLE 3

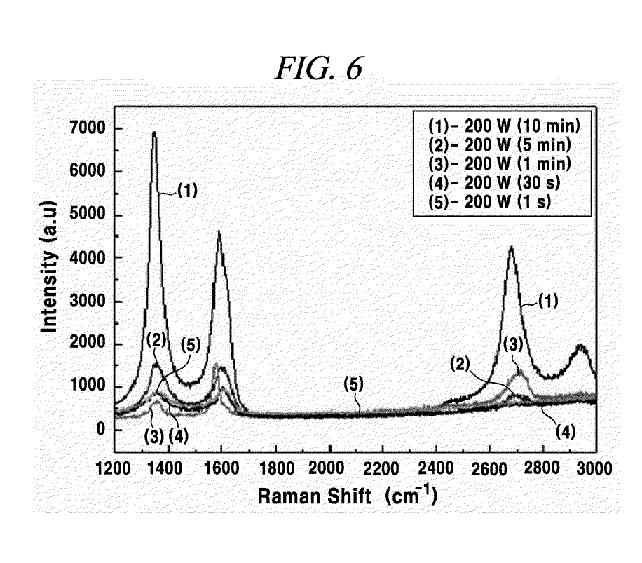

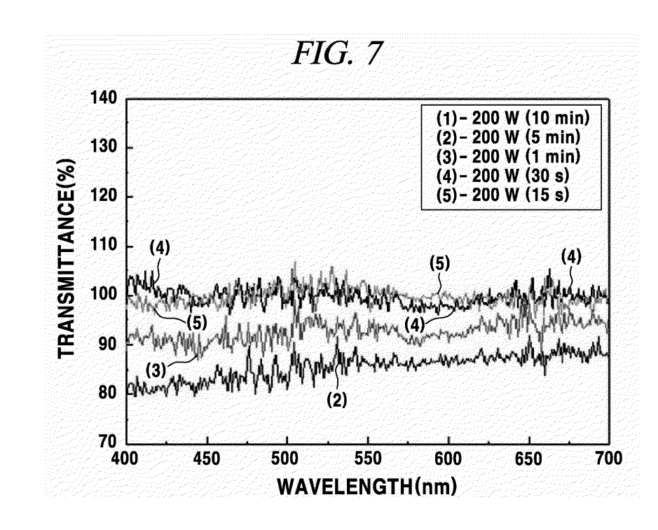

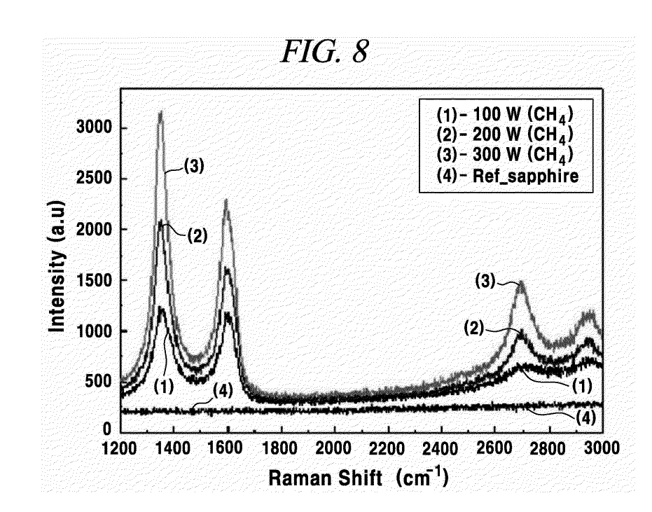

Graphene was formed in the same manner as Example 1. A change in a Raman spectrum, an electrical characteristic (change in resistance), and transmittance of the graphene was observed with change in a reaction time from about 15 seconds to about 10 minutes. A result of the observation is shown in Table 2 and FIGS. 6 and 7.

TABLE 2

| | Plasma | Reaction | | | | Transmittance |
|---|---|---|---|---|---|---|
| | power | time | | Resistance | | (%, 550 nm) |
| 1 | 200 W | 10 | min. | 666 | Ω | 34 |
| 2 | 200 W | 5 | min. | 0.85 | kΩ | 86.2 |
| 3 | 200 W | 1 | min. | 2.8 | kΩ | 92 |
| 4 | 200 W | 30 | sec. | 13.6 | kΩ | 97 |
| 5 | 200 W | 15 | sec. | 11.3 | kΩ | 98 |

Referring to Table 2 and FIG. 7, as a reaction time of the graphene was decreased, transmittance was increased to about 98% but an electrical characteristic (resistance) was increased. Referring to FIG. 6, an intensity of a 2D peak was greatly decreased. It could be seen that a quality of the formed graphene was deteriorated.

### EXAMPLE 4

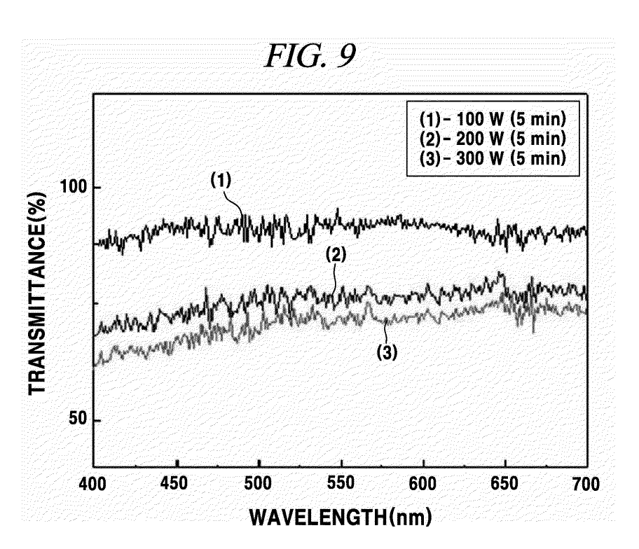

Graphene was formed in the same manner as Example 1 except that CH₄ was used as a carbon source instead of C₂H₂. A change in a Raman spectrum, an electrical characteristic (change in resistance), and transmittance of the graphene was observed with change in a plasma power. A result of the observation is shown in Table 3 and FIGS. 8 and 9.

TABLE 3

| | Plasma | Reaction | | | Transmittance |
|---|---|---|---|---|---|
| | power | time | Resistance | | (%, 550 nm) |
| 1 | 100 W | 5 min. | 1.57 | Ω | 92 |
| 2 | 200 W | 5 min. | 0.882 | Ω | 78 |
| 3 | 300 W | 5 min. | 0.589 | Ω | 72 |

Referring to FIG. 8, as a plasma power was increased, an intensity of a 2D peak was increased like as from a case where the acetylene gas was used. Therefore, it could be seen that crystallinity of the graphene was improved. Referring to Table 3 and FIG. 9, resistance and transmittance were relatively decreased.

The examples have been provided for illustration of the present disclosure, but the present disclosure is not limited thereto. It is clear to those skilled in the art that the examples can be changed and modified in various ways within the scope of the present disclosure.

1. A preparing method of graphene, comprising:
supplying a reaction gas including a carbon source and heat onto a substrate and making a reaction to form graphene on the substrate.

2. The method of claim 1,
wherein the graphene is formed by an inductively coupled plasma-chemical vapor deposition (ICP-CVD) process, a low pressure chemical vapor deposition (LPCVD) process or an atmospheric pressure chemical vapor deposition (APCVD) process.

3. The method of claim 1,
wherein a temperature of the reaction is about 1,000° C. or less.

4. The method of claim 1, further comprising:
cooling the formed graphene.

5. The method of claim 1, further comprising:
patterning the formed graphene.

6. The method of claim 1,
wherein the substrate is transparent.

7. The method of claim 1,
wherein the substrate is patterned.

8. The method of claim 1,
wherein the substrate includes one selected from the group consisting of an oxide, a nitride, and combinations thereof.

9. The method of claim 8,
wherein the oxide is selected from the group consisting of MgO, Al₂O₃, SiO₂, ZrO₂, Y₂O₃, Cr₂O₃BeO, SnO₂, Eu₂O₃, TiO₂, TiO₂·Al₂O₃, Gd₂O₃, UO₂, (U—Pu)O₂, ThO, and combinations thereof.

10. The method of claim 8,
wherein the nitride is selected from the group consisting of Si₃N₄, AlN, TiN, BN, CrN, WrN, TaN, BeSiN₂, Ti₂AlN, and combinations thereof.

11. The method of claim 1, further comprising:
doping the formed graphene with a dopant including an organic dopant, an inorganic dopant or a combination thereof.

12. A preparing method of graphene, comprising:
loading a substrate into an ICP-CVD chamber by using a load-locked chamber; and
supplying a carbon source into the ICP-CVD chamber to form graphene by an ICP-CVD process at about 1,000° C. or less.

13. The method of claim 12,
wherein characteristics of the graphene are controlled by adjusting a plasma power, a reaction time or a cooling rate during the ICP-CVD process.

14. A graphene sheet comprising:
a substrate; and
graphene formed on the substrate by a method of claim 1.

15. The graphene sheet of claim 14,
wherein the substrate includes one selected from the group consisting of an oxide, a nitride, and combinations thereof.

16. The graphene sheet of claim 15,
wherein the oxide includes one selected from the group consisting of MgO, Al₂O₃, SiO₂, ZrO₂, Y₂O₃, Cr₂O₃BeO, SnO₂, Eu₂O₃, TiO₂, TiO₂·Al₂O₃, Gd₂O₃, UO₂, (U—Pu)O₂, ThO, and combinations thereof.

17. The graphene sheet of claim 15,
wherein the nitride includes one selected from the group consisting of Si₃N₄, AlN, TiN, BN, CrN, WrN, TaN, BeSiN₂, Ti₂AlN, and combinations thereof.

18. The graphene sheet of claim 14,
wherein the graphene sheet is from about 1 mm to about 5 m wide and long.

19. The graphene sheet of claim 14,
wherein the graphene is doped with a dopant including an organic dopant, an inorganic dopant or a combination thereof.

20. A device including graphene formed by a method of claim 1.
